(19) United States
(12) Patent Application Publication
(10) Pub. No.: US 2022/0396242 A1
(43) Pub. Date: Dec. 15, 2022

(54) VEHICULAR WINDSHIELD WIPER CONTROL SYSTEM

(71) Applicant: Magna Electronics Inc., Auburn Hills, MI (US)

(72) Inventor: Prathyush Kumar Keshipeddy, Troy, MI (US)

(21) Appl. No.: 17/806,802

(22) Filed: Jun. 14, 2022

Related U.S. Application Data
(60) Provisional application No. 63/202,514, filed on Jun. 15, 2021.

(51) Int. Cl. B60S 1/08; B60S 1/38; B60R 11/04

(52) U.S. Cl. CPC B60S 1/0818; B60S 1/38; B60R 11/04; B60R 2011/0026

(57) ABSTRACT

A vehicular windshield wiper control system includes a camera disposed at a vehicle and viewing through a windshield of the vehicle and an electronic control unit (ECU). Electronic circuitry of the ECU includes an image processor. The system, based on processing of image data captured by the camera, is operable to determine presence of a substance at an outer surface of the windshield. The system includes a windshield wiper having a rubber wiping blade and a cleaning element. The system is operable to (i) cause the rubber wiping blade to engage the windshield and/or (ii) cause the cleaning element to engage the windshield. Responsive to determining presence of the substance, the system causes the cleaning element to engage the windshield. With the rubber wiping blade and/or cleaning element engaging the outer surface of the windshield, the system moves the rubber wiping blade and/or cleaning element along the windshield.

### CROSS REFERENCE TO RELATED APPLICATION

The present application claims the filing benefits of U.S. provisional application Ser. No. 63/202,514, filed Jun. 15, 2021, which is hereby incorporated herein by reference in its entirety.

### FIELD OF THE INVENTION

The present invention relates generally to vehicular windshield wipers and, more particularly, to a control system for vehicular windshield wipers.

### BACKGROUND OF THE INVENTION

It is known to provide windshield wipers at a vehicle that operate responsive to a rain sensor, such as the types disclosed in U.S. Pat. Nos. 6,353,392; 6,313,454; 6,320,176 and/or 7,480,149, which are hereby incorporated herein by reference in their entireties Such wipers may operate at intermittent speeds responsive to a determination of presence of rain and/or an intensity of rain.

Additionally, it is known to provide systems for heating or defrosting a windshield, such as heating vents that direct hot air at the interior side of the windshield or electric defroster grids adhered to the windshield, to remove snow and ice from the exterior side of the windshield.

### SUMMARY OF THE INVENTION

The control system includes a control or electronic control unit (ECU) for a vehicle that utilizes one or more sensors (such as an optical sensor) to capture sensor data and processes captured sensor data to determine presence of a substance (e.g., rain or snow or ice or dirt or the like) at the outer surface of a windshield of the vehicle, and provides a windshield wiper at the windshield that includes a rubber element (such as a wiper blade) and a cleaning element (such as a brush or scraper or tool). Responsive to determining presence of the substance at the windshield, the system selectively engages one of the rubber element or the cleaning element or tool at the windshield and moves the selected rubber element or cleaning element or tool along the outer surface of the windshield to remove the detected substance.

According to one aspect, a vehicular control system includes a sensor, such as a camera (such as a CMOS camera having at least one million photosensors arranged in rows and columns) disposed at a vehicle equipped with the vehicular control system and viewing through a windshield of the vehicle. An electronic control unit (ECU) includes electronic circuitry and associated software. The electronic circuitry of the ECU includes a processor for processing image or sensor data captured by the sensor to determine presence of a substance at the outer surface of the windshield. A windshield wiper is disposed at the outer surface of the windshield and includes a rubber wiping element and a cleaning element. The system, based on the determined presence of the substance at the outer surface of the windshield, selectively engages at least one of the rubber element or the cleaning element at the windshield. The system, with the rubber element engaged at the outer surface of the windshield, controls operation of the windshield wiper to move the rubber element along the outer surface of the windshield. The system, with the cleaning element engaged at the outer surface of the windshield, controls operation of the windshield wiper to move the cleaning element along the outer surface of the windshield.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle equipped with a windshield wiper control system;

FIG. 2 shows plan views of a windshield wiper having a rubber strip, brush bristles, and scraper teeth that may be selectively engaged at an outer surface of the windshield;

FIG. 3 is a flowchart of a method of operating the windshield wiper control system to clear the outer surface of the windshield using the windshield wiper; and

FIG. 4 is a flowchart of another method of operating the windshield wiper control system to clear the outer surface of the windshield using the windshield wiper.

### DESCRIPTION OF THE PREFERRED EMBODIMENTS

A control system for a vehicle operates to capture sensor data representative of an outer surface of a windshield of a vehicle and processes the captured sensor data to determine presence of a substance at the outer surface of the windshield and command a windshield wiper system of the vehicle. The control system includes a data processor or data processing system that is operable to receive sensor data from one or more sensors disposed at the vehicle and provide a command to the windshield wiper system to control one or more windshield wipers at the vehicle.

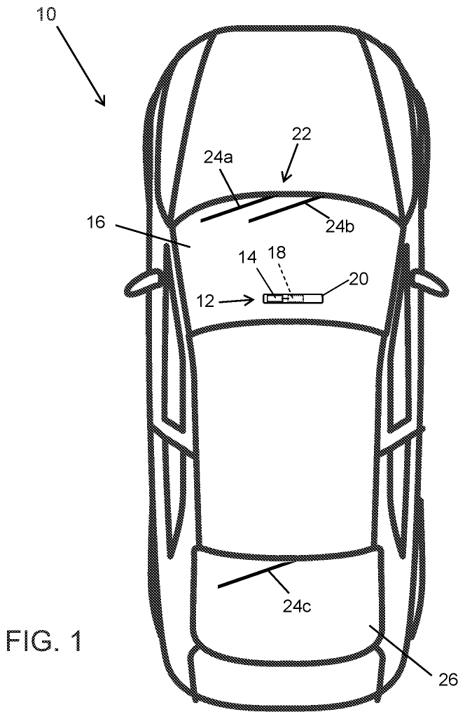

Referring now to the drawings and the illustrative embodiments depicted therein, a vehicle 10 includes a control system 12 that includes at least one sensor 14 (such as an optical sensor or a rain detecting sensor or a camera) disposed at the vehicle and configured to capture sensor data representative of a view through the windshield. Based on the sensor data through the windshield, the system may determine a condition at an outer surface of a windshield 16 of the vehicle 10 (FIG. 1). The control system 12 includes a control or an electronic control unit (ECU) 18 having electronic circuitry and associated software, with the electronic circuitry including a data processor or image processor that is operable to process sensor and/or image data captured by the sensor 14, whereby the system 12 may determine presence of a substance (e.g., moisture, precipitation (such as rain or snow), ice, dirt, insects, etc.) at the outer side or surface of the windshield 16 via processing of the captured sensor data at the ECU 18 and provide a command to a windshield wiper system 22 of the vehicle to control one or more windshield wipers to remove the substance from the outer surface of the windshield. For example, the vehicle 10 may be equipped with a driver's side windshield wiper 24a and a passenger's side windshield wiper 24b at the front windshield 16 of the vehicle and optionally may also include a rear wiper 24c at the rear window 26 of the vehicle, and the ECU 18 may process sensor data and provide a command to the wiper system 22 to control one or more of the wipers. Although shown in FIG. 1 as being part of or incorporated in or at an interior rearview mirror assembly 20 of the vehicle, the ECU 18 and/or the one or more sensors 14 may be disposed elsewhere at or in or exterior the vehicle, such as at a windshield mounted electronics module (WEM). The data transfer or signal communication to and from the sensor, the ECU, and the windshield wiper system may comprise any suitable data or communication link, such as a vehicle network bus or the like of the equipped vehicle.

Currently, if the front windshield and/or rear window is covered with snow or ice and traditional vehicle windshield wipers are insufficient to remove the snow or ice, a driver may clean the windshield using windshield equipment (such as a hand held cleaning brush, ice scraper and/or washer fluid). The driver may also clear the snow or ice by melting the snow or ice via a heater disposed at the in-cabin side of the windshield that is operable when the vehicle is running. Under extreme cold temperatures, snow may turn into solid ice and it may become difficult for the driver to clear. Additionally, manual cleaning methods may require the driver to stand outside the vehicle in cold conditions. Current windshield clearing and cleaning methods may also be insufficient to remove other substances, such as dirt and debris from the windshield. For example, the use of traditional windshield wipers and washer fluid may be insufficient to remove bugs or heavy mud. Presence of such substances at the windshield can obstruct a driver's view through the windshield. Even when traditional methods successfully remove significant dirt and debris, such methods require excessive use of washer fluid and/or a substantially long wiper cycle (i.e., the windshield wipers must wipe the windshield a significant number of times), which further obstructs the driver's view for an extended amount of time, and provides considerable wear on the wiper blade. Additionally, even when a driver manually clears the windshield, the driver may only clear portions of the windshield necessary for the driver to see through the windshield without clearing portions of the windshield necessary for one or more sensors of the vehicle to view through the windshield. For example, the driver may not be aware of the position of sensors viewing through the windshield. Thus, although the driver may be able to view through the windshield to operate the vehicle, the operation of advanced driver assist systems (ADAS) that require sensor data captured by sensors viewing through the windshield may be limited.

The system 12 provides a smart wiper control system 22 which uses sensor data captured by one or more sensors of the vehicle and representative of a condition of the windshield to determine whether precipitation or foreign substances are present at the windshield, and operates wipers 24 of the vehicle based on the captured sensor data. For example, the system may be operable to determine presence of precipitation (e.g., rain or snow) at the windshield and determine presence of substances, such as substances having a dense or solid or non-liquid consistency (e.g., ice, debris, bugs, leaves, and the like), and the system may distinguish between precipitation or substances having solid consistencies to control operation of the wipers. The sensor may include one or more of a camera of a WEM viewing through the windshield of the vehicle and having a field of view forward of the vehicle, an optical sensor, a rain sensor, a temperature sensor, or any other suitable sensor capable of determining a weather condition or substance at the windshield. For example, upon vehicle startup, the system may determine that a substance is present at the windshield based on a determination that image data captured by the forward viewing camera includes occlusions. Responsive to determination of the substance at the windshield, the system operates the wipers 24 and may adjust or control operation based on the initial (or continued) captured sensor data. Similarly, a sensor may be disposed at and/or viewing through the rear window 26 so that control of the operation of the rear wiper 24c may be based on sensor data representative of a condition of the outer surface of the rear window 26.

The wipers 24 may include smart wipers 24a-c that have a rubber element 28 such as a strip or blade (for traditional windshield wiper use to wipe precipitation from the windshield) and one or more tools or clearing or cleaning elements, such as a scraper element 32 optionally having hardened teeth and/or a brush element 30, to automatically scrape or remove or clean snow, ice, and/or other substances from the windshield. The system 12 may engage the one or more tools or cleaning elements with the windshield of the vehicle (such as responsive to a user input or automatically based on a determined windshield condition) and operate the wiper 24 to move the tool along the outer surface of the windshield so that the tool cleans the windshield. This reduces the effort required to clean the windshield in a snowy environment or when substances build up on the windshield. Optionally, the optical sensor may detect left over ice and snow so the system can determine when to stop the cleaning process. The system 12 may operate the wiper 24 and/or determine which tool to engage with the windshield based on processing data captured by the sensor.

The wiper or smart wiper 24 includes the rubber wiper blade 28 and one or more tools and the system 12 selectively engages the wiper blade 28 or the one or more tools with the windshield. The system 12 is operable to selectively engage and disengage the wiper blade 28 and one or more tools at the windshield in any suitable manner. For example, the wiper 24 may include the rubber strip and the brush 30 and scraper 32, where each tool is disposed along the length of a rotating support element such that only one of the rubber strip, brush, or scraper engages the windshield at one time. The system may rotate the support element (such as via a motor) to selectively engage the chosen element with the windshield.

Optionally, the rubber element 28, brush element 30, and scraper element 32 may each comprise a respective blade and the system may selectively engage and disengage one or more of the elements with the windshield. For example, the rubber element 28 and the one or more tools or cleaning elements may be disposed within a housing and when one or more elements are selected, the one or more elements may be extended from the housing to engage the windshield. Thus, each tool may be disposed on a separate length of blade or structure that is able to be individually engaged with the windshield. This allows each tool to be engaged with the windshield alone or for more than one tool to be engaged with the windshield at one time. Additionally, each blade may be separately removed from the wiper assembly and replaced (such as if one or more tools wears over time).

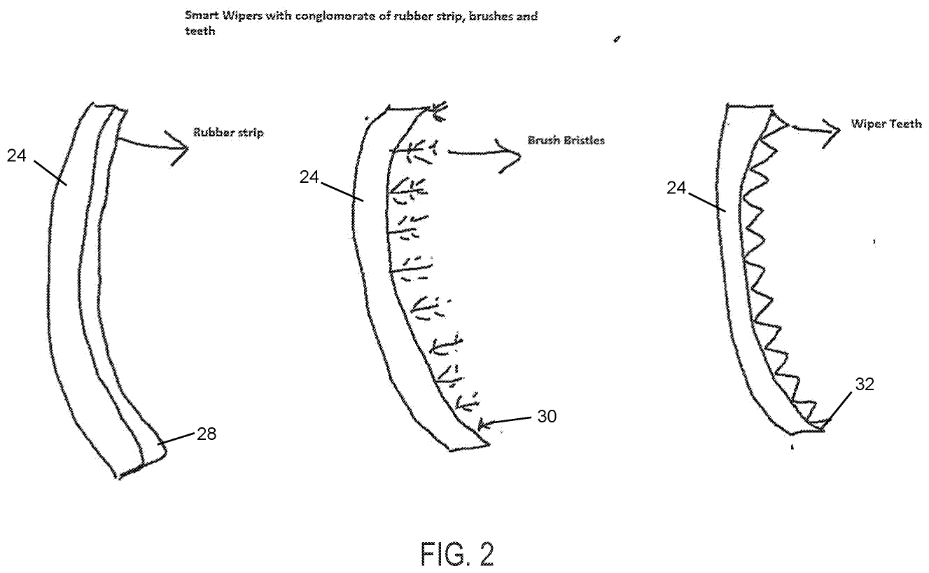

Referring now to FIG. 2, the wiper system 22 includes one or more windshield wipers 24 configured to selectively engage one of a conglomerate of a rubber strip 28, brushes 30, and teeth 32. The system may determine a condition at the windshield, such as via processing at the ECU of sensor data captured by the one or more sensors at the vehicle, and deploy or otherwise enable one or more of the rubber strip 28, brush bristles 30, and/or hardened teeth 32 to engage the windshield. Optionally, the system may selectively engage one or more of the tools responsive to a user input. The system engages the selected tool with the windshield and operates the wiper to move the tool along the outer surface of the windshield, thereby cleaning or clearing or loosening the substance from the windshield.

The teeth may comprise a hardened plastic or any suitable material configured to not scratch the glass of the windshield. Optionally, the toothed element and/or brush element may be longitudinally moved during the back and forth (laterally moving) wiping operation so that the teeth do not simply create and follow a groove across the ice. For example, the wiper may vibrate as the brush or hardened teeth move across the windshield.

For example, in a normal or default operating condition, and responsive to a rain sensor or a manual input from the driver, the wiper may engage the rubber strip at the windshield so that when the wiper system is operated, the wiper may operate like a traditional wiper to clear rain or other precipitation from the windshield. The system may determine the presence (and optionally the intensity) of rain at the windshield and automatically operate the wipers with the rubber strip engaged or may operate responsive to a user command. Optionally, the system may control or adjust operation of the wiper as the vehicle travels along the road to optimize or improve the quality of the sensor data captured by the sensor. For example, the driver may provide an input to operate the wipers at a first, slower speed and the system may subsequently determine and operate the wipers at a second, faster speed based on poor sensor data quality at the first speed.

One or more of the other tools or cleaning elements may be engaged with the windshield when selected by the driver of the vehicle or when the system determines a condition. For example, the brush 30 may be used to clean the windshield when the system determines that mud or dirt or bugs or other contaminants are present at the windshield and the scraper 32 may be used when ice or snow is determined at the windshield. The system may determine a change in the condition at the windshield (such as that the windshield is clean or a change in the density of the substance) and modify its operation according to the determined change in the condition.

When the system, such as upon vehicle start up, determines the presence of heavy ice at the windshield, the system engages the scraper of the wiper at the windshield. For example, the system may process captured sensor data to determine that a view of the sensor through the windshield of the vehicle is obscured. Based on temperature data, the system may determine that the foreign substance at the windshield is ice and use the scraper to clear the windshield. If the system determines that the substance is not ice (such as based on a warm temperature reading or based on image data processing), the system may instead use the brush. The system may operate the wiper to move the scraper along the outer surface of the windshield, breaking up and removing ice.

While operating the scraper, the system may determine a condition change and adjust operation of the wiper. For example, while operating with the scraper's teeth engaged at the windshield, the system may determine a change in the density of the ice such that the system decides to engage the brush or wiper at the windshield to finish cleaning the windshield.

When the system determines presence of substances at the windshield suitable for removal with the brush, the system engages the brush of the wiper at the windshield and move the wiper along the outer surface of the windshield to remove or loosen the substance from the windshield. Substances suitable for removal with the brush may include light ice, snow, dirt, bugs, leaves, and the like. Optionally, the system may determine that the foreign substance has been loosened or removed using the brush or scraper, operate sprayers to apply washer fluid to the windshield, and use the rubber blade to complete an automatic cleaning cycle of the windshield.

Optionally, the system may only engage the one or more tools (i.e., other than the rubber strip) when it is safe for the driver and other vehicles to do so, such as only upon vehicle startup or when the vehicle is travelling below a threshold speed. For example, ice on the windshield may be determined to not affect the driver's field of view through the windshield and the vehicle may be travelling at a significant speed where removal of the ice from the windshield could cause damage to other vehicles travelling within the vicinity of the equipped vehicle.

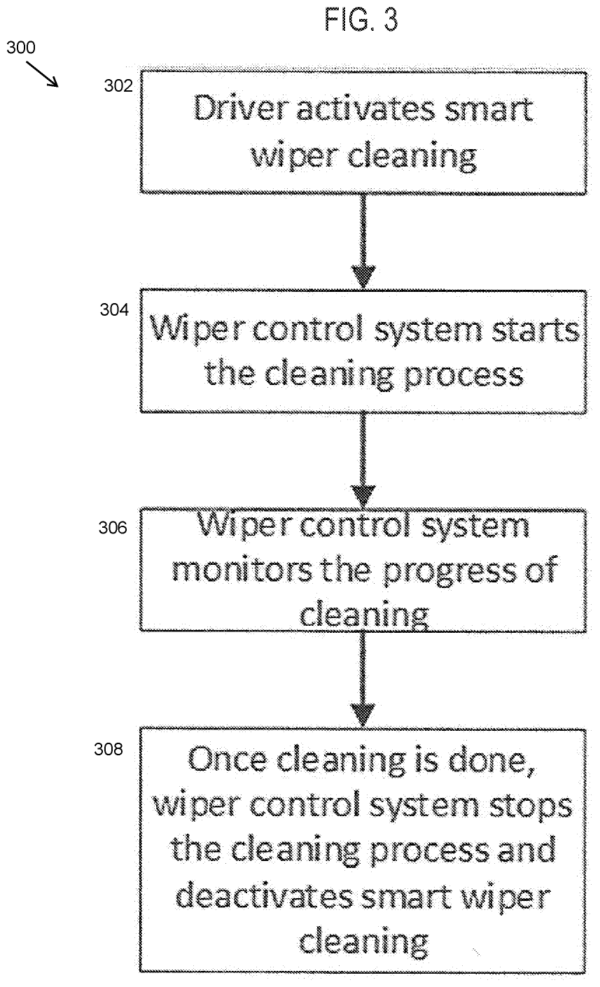

With reference to FIG. 3, a flowchart 300 of an example method for cleaning a windshield using the control system for windshield wipers is shown. At step 302, a driver may activate the cleaning process, such as via an input at the interior of the vehicle. At step 304, the control system starts the cleaning process. For example, the system may capture and process sensor data representative of the view (of the driver or sensor) through the windshield and determine presence of a substance at the windshield. Responsive to determining presence of the substance at the windshield, the system may engage a tool of the wiper at the windshield and operate the wiper to move the tool along the exterior surface of the windshield. At step 306, the system monitors the progress of the cleaning, such as via continued capture and processing of sensor data representative of the condition of the view through windshield. Optionally, the system may adjust operation of the wiper based on the continued processing of sensor data. For example, the system may adjust the speed of cleaning, adjust the tool engaged at the windshield, or cease the cleaning process. At step 308, the system determines that the process is done, stops operation of the wiper, and deactivates the smart wiper. For example, the system may determine the windshield is clean, stop operation of the wiper, disengage the tool from the windshield and reengage the rubber strip of the wiper for subsequent traditional wiper use.

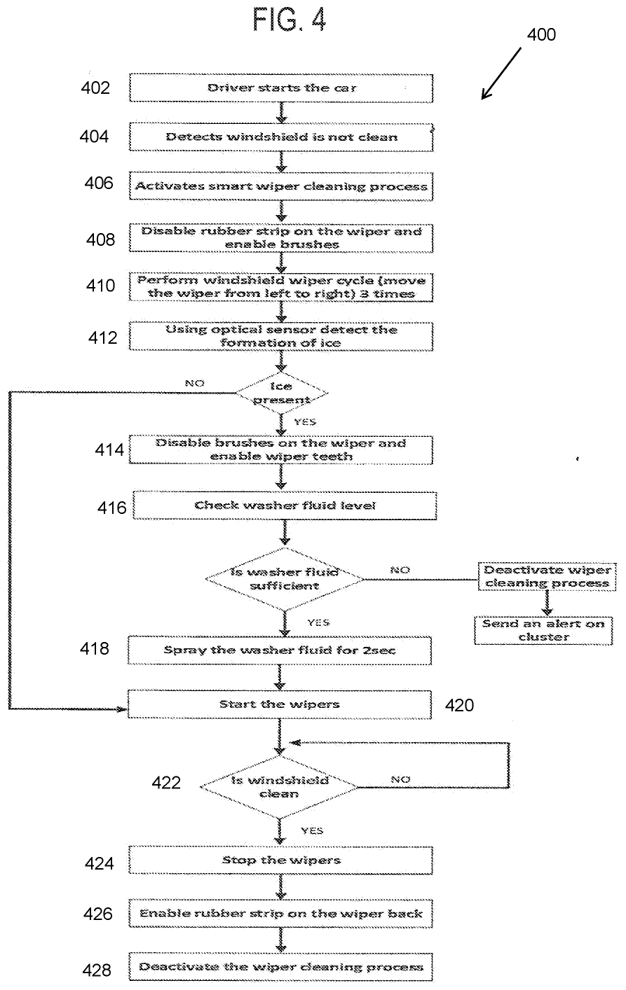

With reference to FIG. 4, another flowchart 400 of an example method for cleaning a windshield using the control system for windshield wipers is shown. At step 402, a driver of the vehicle starts the vehicle. Upon startup, at step 404, the system, via processing of sensor data representative of the condition of the windshield, detects presence of a substance at the windshield and, at step 406, activates the wiper cleaning process. After activating the wiper cleaning process, the system at step 408 disables or disengages the rubber strip of the wiper and enables or engages the brushes of the wiper at the windshield (such as via rotating the wiper to position the brushes at the windshield surface). At step 410, the system performs a windshield wiper cycle (i.e., moves the wiper along the outer surface of the windshield, such as from left to right) a selected number of times, such as three times. At step 412, the system, via processing of data captured by the optical sensor, determines whether or not ice is present at the windshield. If at step 412 the system determines that ice is not present at the windshield, the system will operate the wipers at step 420 with the brush engaged at the windshield to clean the other determined substance. If ice is determined to be present, the system, at step 414, disables or disengages the brushes of the wiper and enables or engages the teeth of the wiper at the windshield (such as via rotating the wiper to position the wiper teeth at the windshield surface). At step 416, the system determines if the washer fluid at the vehicle is sufficient. If the washer fluid is not sufficient, the system deactivates the wiper cleaning process and sends an alert to the driver of the vehicle, such as via a message or icon at the instrument cluster. If the washer fluid is sufficient, the system at step 418 sprays the washer fluid (such as for two seconds) onto the windshield and activates the wipers at step 420 (with the teeth engaged at the windshield).

After the system begins operating the wipers at step 420 (with either the brush or the teeth engaged with the windshield surface), the system, at step 422, operates a feedback loop to continue operating the wipers until the windshield is determined to be clean. Once the windshield is determined to be clean, the system at step 424 stops movement of the wipers, disables or disengages the teeth or brush of the wiper, and enables or engages the rubber strip of the wiper back at the windshield at step 426. At step 428, the system deactivates the wiper cleaning process.

Thus, the vehicular control system provides a control system configured to process sensor data representative of an exterior surface or condition of the windshield of a vehicle to determine presence of a substance at the exterior surface of the windshield. For example, the system may process sensor data (such as sensor data captured by an optical sensor or a camera) and determine that ice or other substance is formed or present at the windshield of the vehicle. Responsive to determining presence of the substance, the system selectively engages a rubber strip or a tool at a windshield wiper at the windshield and operates the wiper to move the selected rubber strip or tool along the outer surface of the windshield. The selected rubber strip or tool is selected depending on the type of substance determined to be present at the windshield and functions to remove the detected ice or other substance from the windshield. The system may, responsive to determining a substance, wipe the windshield with one of the wiper elements and process sensor data to determine what effect the wiping has on the substance (e.g., if the brush is used with ice at the windshield, the brush may roughen or scratch, but not remove, the ice, and the system may determine that the scraping teeth are needed to remove the ice). Responsive to determining that the wiper element should be changed for the particular substance present at the windshield, the system adjusts the wiper so that the appropriate wiper element is engaged with the windshield (e.g., adjusts the wiper so that the toothed element is engaged with ice present at the windshield).

The vehicular control system may be integrated with or utilize sensors and/or cameras of other vehicular systems. For example, the vehicle may be equipped with a forward viewing camera that views through the windshield of the vehicle, such as for an object detection, driving assistance system, or the like, and the system may determine via processing of image data captured by the forward viewing camera that ice or another substance is present at the windshield.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the control system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Optionally, the camera may comprise a forward viewing camera, such as disposed at a windshield electronics module (WEM) or the like. The forward viewing camera may utilize aspects of the systems described in U.S. Pat. Nos. 9,896,039; 9,871,971; 9,596,387; 9,487,159; 8,256,821; 7,480,149; 6,824,281 and/or 6,690,268, and/or U.S. Publication Nos. US-2020-0039447; US-2015-0327398; US-2015-0015713; US-2014-0160284; US-2014-0226012 and/or US-2009-0295181, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular windshield wiper control system, the vehicular windshield wiper control system comprising:
a camera disposed at a vehicle equipped with the vehicular windshield wiper control system and viewing through a windshield of the vehicle, the camera capturing image data;
wherein the camera comprises a CMOS imaging array, and wherein the CMOS imaging array comprises at least one million photosensors arranged in rows and columns;
an electronic control unit (ECU) comprising electronic circuitry and associated software;
wherein the electronic circuitry of the ECU comprises an image processor for processing image data captured by the camera;
wherein the vehicular windshield wiper control system, based on processing at the ECU of image data captured by the camera, is operable to determine presence of a substance at an outer surface of the windshield, and wherein the substance comprises at least one selected from the group consisting of (i) ice, (ii) dirt, (iii) insects and (iv) debris;
a windshield wiper disposed at the outer surface of the windshield and comprising a rubber wiping blade and a cleaning element;
wherein the vehicular windshield wiper control system is operable to at least one selected from the group consisting of (i) cause the rubber wiping blade to engage the outer surface of the windshield and (ii) cause the cleaning element to engage the outer surface of the windshield;
wherein the vehicular windshield wiper control system, responsive to determining, via processing at the ECU of image data captured by the camera, presence of the substance at the outer surface of the windshield, causes the cleaning element to engage the outer surface of the windshield;
wherein the vehicular windshield wiper control system, with the cleaning element engaging the outer surface of the windshield, controls operation of the windshield wiper to move the cleaning element along the outer surface of the windshield;
wherein the vehicular windshield wiper control system, responsive at least in part to not determining, via processing at the ECU of image data captured by the camera, presence of the substance at the outer surface of the windshield, causes the rubber wiping blade to engage the outer surface of the windshield; and
wherein, with the rubber wiping blade engaging the outer surface of the windshield, the vehicular windshield wiper control system controls operation of the windshield wiper to move the rubber wiping blade along the outer surface of the windshield.

2. The vehicular windshield wiper control system of claim 1, wherein the cleaning element comprises a brush.

3. The vehicular windshield wiper control system of claim 1, wherein the cleaning element comprises a scraper.

4. The vehicular windshield wiper control system of claim 3, wherein the scraper comprises hardened teeth.

5. The vehicular windshield wiper control system of claim 1, wherein the windshield wiper includes a plurality of cleaning elements, and wherein the vehicular windshield wiper control system selectively causes at least one selected from the group consisting of the rubber wiping blade and one of the plurality of cleaning elements to engage the outer surface of the windshield.

6. The vehicular windshield wiper control system of claim 5, wherein the plurality of cleaning elements includes a brush and a scraper comprising hardened teeth.

7. The vehicular windshield wiper control system of claim 1, wherein, in a default position, the rubber wiping blade is engaged with the outer surface of the windshield, and wherein the vehicular windshield wiper control system, responsive to determining presence of the substance at the outer surface of the windshield, causes the cleaning element to engage the outer surface of the windshield.

8. The vehicular windshield wiper control system of claim 7, wherein, responsive to determining presence of the substance at the outer surface of the windshield, the vehicular windshield wiper control system causes the rubber wiping blade to disengage from the outer surface of the windshield.

9. The vehicular windshield wiper control system of claim 1, wherein the vehicular windshield wiper control system, based on processing at the ECU of image data captured by the camera, determines absence of the substance at the outer surface of the windshield, and wherein the vehicular windshield wiper control system, responsive to determining the absence of the substance at the outer surface of the windshield, causes the rubber wiping blade to engage the outer surface of the windshield.

10. The vehicular windshield wiper control system of claim 1, wherein the vehicular windshield wiper control system, with the cleaning element engaging the outer surface of the windshield, controls operation of the windshield wiper to move the cleaning element longitudinally while moving the cleaning element laterally along the outer surface of the windshield.

11. The vehicular windshield wiper control system of claim 1, wherein the vehicular windshield wiper control system, based on processing at the ECU of image data captured by the camera, determines a condition at the outer surface of the windshield, and wherein the vehicular windshield wiper control system, based on the determined condition, adjusts operation of the windshield wiper.

12. The vehicular windshield wiper control system of claim 11, wherein, with one of the rubber wiping blade and the cleaning element engaging the outer surface of the windshield, the vehicular windshield wiper control system, based on the determined condition, adjusts operation of the windshield wiper to cause the other of the rubber wiping blade and the cleaning element to engage the outer surface of the windshield.

13. The vehicular windshield wiper control system of claim 1, wherein the vehicular windshield wiper control system, via processing at the ECU of image data captured by the camera, is operable to determine presence of precipitation at an outer surface of the windshield, and wherein the vehicular windshield wiper control system, responsive to determining, via processing at the ECU of image data captured by the camera, presence of precipitation at the outer surface of the windshield, causes the rubber wiping blade to engage the outer surface of the windshield.

14. The vehicular windshield wiper control system of claim 13, wherein precipitation comprises at least one selected from the group consisting of rain and snow.

15. The vehicular windshield wiper control system of claim 1, wherein the camera comprises the ECU.

16. The vehicular windshield wiper control system of claim 1, wherein the ECU is located in the vehicle remote from the camera.

17. A vehicular windshield wiper control system, the vehicular windshield wiper control system comprising:
a camera disposed at a vehicle equipped with the vehicular windshield wiper control system and viewing through a windshield of the vehicle, the camera capturing image data;
wherein the camera comprises a CMOS imaging array, and wherein the CMOS imaging array comprises at least one million photosensors arranged in rows and columns;
an electronic control unit (ECU) comprising electronic circuitry and associated software;
wherein the electronic circuitry of the ECU comprises an image processor for processing image data captured by the camera;
wherein the vehicular windshield wiper control system, based on processing at the ECU of image data captured by the camera, is operable to determine presence of a substance at an outer surface of the windshield, and wherein the substance comprises at least one selected from the group consisting of (i) ice, (ii) dirt, (iii) insects and (iv) debris;
a windshield wiper disposed at the outer surface of the windshield and comprising a rubber wiping blade and a plurality of cleaning elements;
wherein the plurality of cleaning elements includes a brush and a scraper comprising hardened teeth;
wherein the vehicular windshield wiper control system is operable to at least one selected from the group consisting of (i) cause the rubber wiping blade to engage the outer surface of the windshield and (ii) cause one cleaning element of the plurality of cleaning elements to engage the outer surface of the windshield;
wherein the vehicular windshield wiper control system, responsive to determining, via processing at the ECU of image data captured by the camera, presence of the substance at the outer surface of the windshield, causes one cleaning element of the plurality of cleaning elements to engage the outer surface of the windshield;
wherein, in a default position, the rubber wiping blade is engaged with the outer surface of the windshield, and wherein the vehicular windshield wiper control system, responsive to determining presence of the substance at the outer surface of the windshield, causes one cleaning element of the plurality of cleaning elements to engage the outer surface of the windshield;
wherein the vehicular windshield wiper control system, with one cleaning element of the plurality of cleaning elements engaging the outer surface of the windshield, controls operation of the windshield wiper to move one cleaning element of the plurality of cleaning elements along the outer surface of the windshield;
wherein the vehicular windshield wiper control system, responsive at least in part to not determining, via processing at the ECU of image data captured by the camera, presence of the substance at the outer surface of the windshield, causes the rubber wiping blade to engage the outer surface of the windshield; and
wherein, with the rubber wiping blade engaging the outer surface of the windshield, the vehicular windshield wiper control system controls operation of the windshield wiper to move the rubber wiping blade along the outer surface of the windshield.

18. The vehicular windshield wiper control system of claim 17, wherein, responsive to determining presence of the substance at the outer surface of the windshield, the vehicular windshield wiper control system causes the rubber wiping blade to disengage from the outer surface of the windshield.

19. A vehicular windshield wiper control system, the vehicular windshield wiper control system comprising:
a camera disposed at a vehicle equipped with the vehicular windshield wiper control system and viewing through a windshield of the vehicle, the camera capturing image data;
wherein the camera comprises a CMOS imaging array, and wherein the CMOS imaging array comprises at least one million photosensors arranged in rows and columns;
an electronic control unit (ECU) comprising electronic circuitry and associated software;
wherein the electronic circuitry of the ECU comprises an image processor for processing image data captured by the camera;
wherein the vehicular windshield wiper control system, based on processing at the ECU of image data captured by the camera, is operable to determine presence of a substance at an outer surface of the windshield, and wherein the substance comprises at least one selected from the group consisting of (i) ice, (ii) dirt, (iii) insects and (iv) debris;
a windshield wiper disposed at the outer surface of the windshield and comprising a rubber wiping blade and a cleaning element;
wherein the vehicular windshield wiper control system is operable to at least one selected from the group consisting of (i) cause the rubber wiping blade to engage the outer surface of the windshield and (ii) cause the cleaning element to engage the outer surface of the windshield;
wherein the vehicular windshield wiper control system, responsive to determining, via processing at the ECU of image data captured by the camera, presence of the substance at the outer surface of the windshield, causes the cleaning element to engage the outer surface of the windshield;
wherein the vehicular windshield wiper control system, with the cleaning element engaging the outer surface of the windshield, controls operation of the windshield wiper to move the cleaning element along the outer surface of the windshield;
wherein the vehicular windshield wiper control system, with the cleaning element engaging the outer surface of the windshield, controls operation of the windshield wiper to move the cleaning element longitudinally while moving the cleaning element laterally along the outer surface of the windshield;
wherein the vehicular windshield wiper control system, responsive at least in part to not determining, via processing at the ECU of image data captured by the camera, presence of the substance at the outer surface of the windshield, causes the rubber wiping blade to engage the outer surface of the windshield;
wherein, with the rubber wiping blade engaging the outer surface of the windshield, the vehicular windshield wiper control system controls operation of the windshield wiper to move the rubber wiping blade along the outer surface of the windshield; and
wherein the vehicular windshield wiper control system, based on processing at the ECU of image data captured by the camera, determines a condition at the outer surface of the windshield, and wherein the vehicular windshield wiper control system, based on the determined condition, adjusts operation of the windshield wiper.

20. The vehicular windshield wiper control system of claim 19, wherein, with one of the rubber wiping blade and the cleaning element engaging the outer surface of the windshield, the vehicular windshield wiper control system, based on the determined condition, adjusts operation of the windshield wiper to cause the other of the rubber wiping blade and the cleaning element to engage the outer surface of the windshield.
